(19) United States
(12) Patent Application Publication
(10) Pub. No.: US 2024/0352787 A1
(43) Pub. Date: Oct. 24, 2024

(54) Roof Shutter

(71) Applicant: Guangdong Scienlan Building Materials Technology Co., Ltd., Foshan (CN)

(72) Inventor: Zhicheng Lin, Huazhou (CN)

(21) Appl. No.: 18/638,778

(22) Filed: Apr. 18, 2024

(30) Foreign Application Priority Data
Apr. 21, 2023 (CN) 2023209320090

(51) Int. Cl. E06B 7/086

(52) U.S. Cl. CPC E06B 7/086

(57) ABSTRACT

The present disclosure provides a roof shutter: including a window frame, a driving device and a louver blade component. One louver blade component includes at least two brackets drivingly connected to one driving device, and a plurality of louver blades arranged between two brackets. One side of each louver blade is rotationally connected to one bracket, and other side is rotationally connected to the window frame, in resulting the louver blades directly swing along an axis which is one side of the louver blade connected to the window frame, and no need to reserve a gap for the louver blades to swing. It prevents rainwater from flowing into the room from the gap.

### TECHNICAL FIELD

The present utility patent relates to a technical field of shutters, and in particular to a roof shutter.

### BACKGROUND

Sunlight rooms are usually fully transparent non-traditional buildings built with glass and metal frames, while current sunlight rooms are generally equipped with an electric shutter on the roof to block the sun. In order to prevent water from entering the shutter of the roof, a drainage groove is installed in the window frame to guide the drainage of rainwater, but the current louver blades are driven through the connection of a rotating shaft arranged in middle part. When the louver blades is rotating, a part of the louver blades will swing downward. In order to provide enough swing space for the louver blades, there is a gap is reserved between the drainage groove and the louver blades. If the drainage groove is insufficient to cope with the water inlet during severe weather such as heavy rain, rainwater will pour into the room from the drainage groove, causing water to enter into the sunlight room.

The prior Chinese utility model patent with publication number CN206157888U, in order to solve this problem, provides a double-layer tempered glass to close the roof of the sunlight room, and the electric shutter is arranged in middle of the tempered glass. However, this structure makes the sunlight room insufficiently ventilated and cannot achieve the purpose of getting close to nature, and the shutter may malfunction in the later use, so the tempered glass will need to be disassembled for repairing the shutter, which is inconvenient for later repair and maintenance.

### SUMMARY

In order to overcome at least one of the defects of the above-mentioned prior art, the present utility patent provides a roof shutter to achieve the purpose of simultaneously satisfying the sunshade and ventilation of the sunlight room and facilitating later repair and maintenance.

In order to achieve the above purpose, the technical solutions adopted by the present utility patent are: a roof shutter, comprising a window frame, a driving device and a louver blade component, wherein the louver blade component is arranged in the window frame and comprises at least two brackets that are drivingly connected to one driving device and a plurality of louver blades arranged between two brackets. One side of each louver blades is rotationally connected to the bracket, and the other side is rotationally connected to the window frame. A drainage groove is arranged on the inner side of the window frame, and one side wall of the drainage groove away from the window frame is in contact with lower part of the louver blades; the louver blades comprise a transverse louver blade, and connecting plates arranged at both ends of the transverse louver blade. The two ends of the connecting plates are rotationally connected to the bracket and the window frame.

Further, top surface of the transverse louver blade is an inclined surface, and bottom surface of the transverse louver blade is a horizontal surface. Upper end of the transverse louver blade located on the inclined surface is connected to the bracket through a rotating shaft, and lower end of the transverse louver blade located on the inclined surface is connected to the window frame through another rotating shaft.

Further, the lower end of the transverse louver blade located on the inclined surface is provided with a baffle extending upward, and the upper end of the transverse louver blade is provided with a jointing part on the inclined surface, and two adjacent transverse louver blades abut against the baffle through the jointing part.

Further, a sealing joint strip is arranged on one side of the jointing part that abuts against the baffle.

Further, one side wall of the drainage groove is connected to the inner side of the window frame, and the other side wall is arranged at lower side of the transverse louver blade. The drainage groove is provided with a sealing joint strip that closely abuts against the transverse louver blade.

Further, the driving device is provided with a connector installed on the bracket, and the connector is rotationally connected to the driving device.

Further, two of the brackets are symmetrically arranged, and the louver blade is located between two brackets. The driving device is installed in the window frame and is drivingly connected to one of the brackets.

Further, each connecting plate's shape corresponds to a cross section shape of each transverse louver blade.

Compared with the prior art, the beneficial effect of the present utility patent is: the previous rotation mode of the louver blades with the middle part as the axis is changed in the way that one side of the louver blades is rotationally connected to the bracket and other side is rotationally connected to the window frame. The present utility patent can directly swing along the axis of one side of the louver blade which is connected to the window frame. At the same time, the drainage groove is arranged to abut against the lower part of the louver blade. There is no need to reserve a gap for the swing of the louver blades, which prevents rainwater from flowing into the room from the gap and satisfies the ventilation of the sunlight room and is convenient for later repair and maintenance.

### BRIEF DESCRIPTION OF DRAWINGS

In order to more clearly illustrate the technical solutions in the embodiments according to the present utility patent or prior art, the figures to be used in the description of the embodiments or prior art will be briefly introduced below. It will be obvious that the figures in the following description are only some of the embodiments of the present utility patent, and that for a person of ordinary skill in the field, other figures can be obtained based on the figures without inventive efforts.

FIG. 1 is a schematic diagram of the overall structure of the present utility patent;

FIG. 2 is a perspective view of the louver blade component of the present utility patent;

FIG. 3 is a schematic diagram of the connection of louver blades in the present utility patent;

FIG. 4 is a schematic structural diagram of the transverse louver blade in the present utility patent;

FIG. 5 is a cross-sectional view of A-A in FIG. 1;

FIG. 6 is a cross-sectional view of B-B in FIG. 1;

FIG. 7 is a partially enlarged schematic diagram of C in FIG. 6;

FIG. 8 is a schematic structural diagram of an existing shutter.

### NOTE OF REFERENCE SIGNS

1. window frame; 2. driving device; 3. louver blade component; 4. drainage groove; 31. bracket; 32. louver blade; 44. sealing joint strip; 200. connector; 300. rotating shaft; 321. transverse louver blade; 322. connecting plate; 321a. baffle; 321b. jointing part.

### DESCRIPTION OF EMBODIMENTS

Below is a further detailed description of the present utility patent based on the figures.

The present embodiment only shows an explanation of the present utility patent and it is not a limitation to the present utility patent. The skilled in the art can make modifications to this embodiment as needed without making any creative contributions after reading this specification, which are always protected by the patent law as long as they are within the scope of the claims of the present utility patent.

It should be noted that when an element is called as being “fixed to” or “arranged on” another element, it can be directly on the other element or indirectly on the other element. When an element is called as being “connected to” another element, it can be directly connected to the other element or indirectly connected to the other element.

It should be noticed that the terms “length”, “width”, “above”, “below”, “front”, “rear”, “left”, “right”, “vertical”, “horizontal”, “top”, “bottom”, “inside” and “outside” which indicates the orientations or positional relationships are based on the orientations or positional relationships shown in the figures. They are only for facilitating describing the present invention and simplifying the description, rather than indicating or implying that the device or component must have a specific orientation, construct and operate in a specific orientation, therefore, it understood as a limitation of the present invention.

In addition, the terms “first” and “second” are used for descriptive purposes only and cannot be understood as indicating or implying relative importance or implicitly indicating the quantity of indicated technical features. Therefore, a feature defined as “first” and “second” may explicitly or implicitly include one or more of these features. In the description of the present invention, “a plurality of” means two or more, unless otherwise specifically defined.

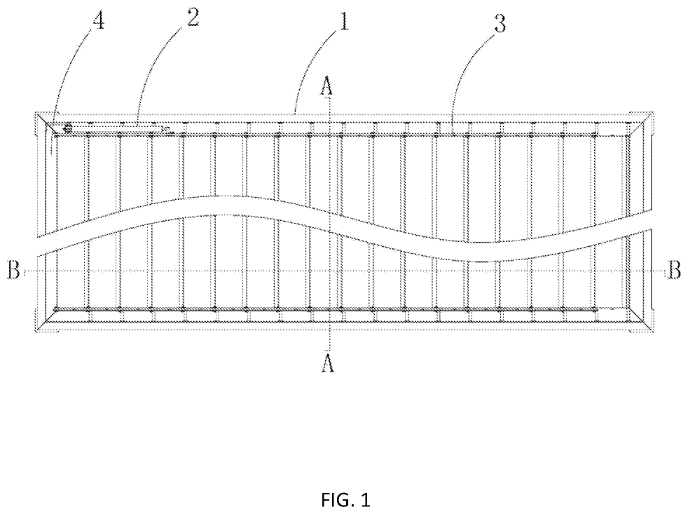

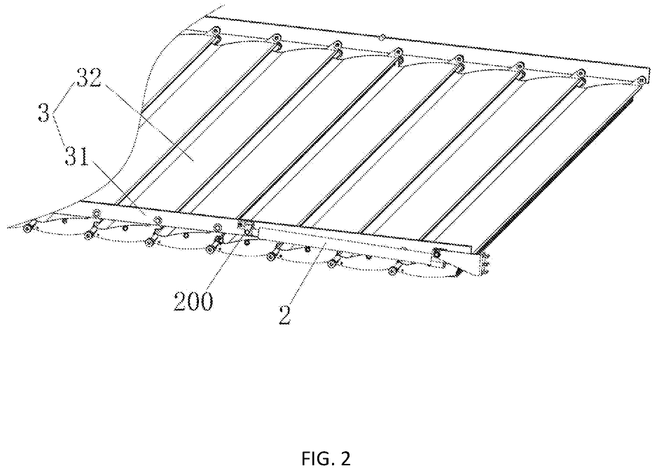

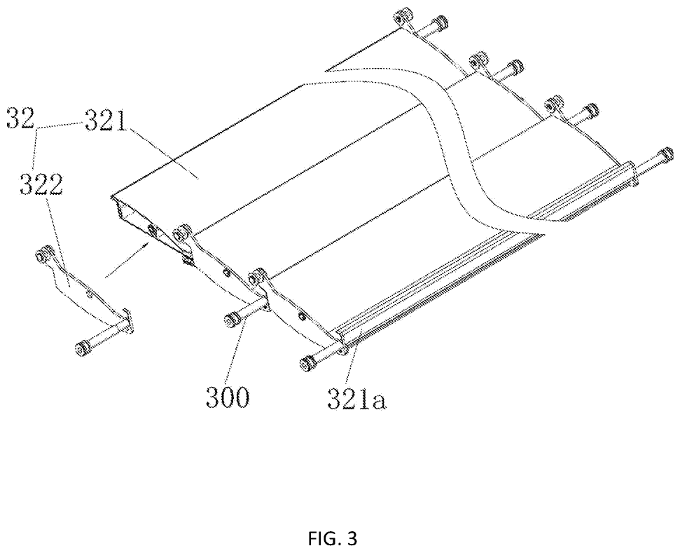

This embodiment relates to a roof shutter, as shown in FIGS. 1-7, comprising a window frame 1, a driving device 2 and a louver blade component 3. The louver blade component 3 is arranged in the window frame 1, and the window frame 1 is installed on the roof of the sunlight room. The driving device 2 can be a telescopic rod or other device. As shown in FIG. 2, one louver blade component 3 comprises at least two bracket 31 drivingly connected to one driving device 2 and a plurality of louver blades 32 arranged between two brackets 31. The bracket 31 comprises two and are arranged symmetrically. The louver blade 32 is arranged between two brackets 31. The driving device 2 is installed in the window frame 1 and is drivingly connected to one of the brackets 31. One side of the louver blades 32 according to width direction is rotationally connected to the bracket 31, and the other side is rotationally connected to the window frame 1. The louver blades 32 swings with one side connected to the window frame 1 as the axis, and this side is lower part. A drainage groove 4 is arranged on the inner side of the window frame 1. The drainage grooves 4 are arranged with four and correspondingly arranged on four inner side walls of the window frame 1. A frame-shaped drainage groove 4 corresponding to the window frame 1 can be directly arranged. The drainage groove 4 is connected to a drainage pipe, which is use to guide the accumulated water in the drainage groove 4 to be discharged. One side wall of the drainage groove 4 away from the window frame 1 is in contact with lower part of the louver blade 32. The drainage groove is located at lower part of the connection between the window frame 1 and the louver blades 32. When the louver blades 32 are closed, the louver blades 32 are in contact with the drainage groove 4.

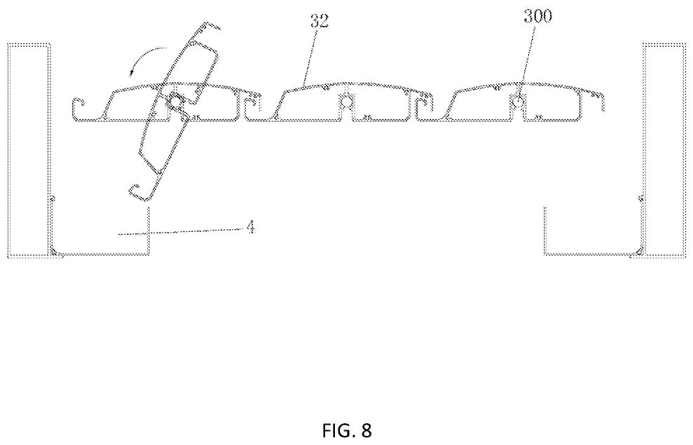

The principle and effect of the roof shutter of the present utility patent is that one side of the louver blade 32 is rotationally connected to the bracket 31, and the other side is rotationally connected to the window frame 1, in this way, the louver blades 32 can swing with one side connected to the window frame 1 as the axis when rotating. As shown in FIG. 2, the louver blade 32 swings from right to left with one side connected to the window frame 1 as the axis. The maximum opening angle can exceed 90 degrees. Then the drainage groove 4 is arranged to abut against the lower part of the louver blade 32. There is no need to reserve a gap for the swing of the louver blades 32. When the shutter is closed, lower side of the louver blades 32 is in contact with the drainage groove 4 to prevent rainwater from flowing into the room from the gap. This changes the previous way of rotating the louver blades with the middle part as the axis. As shown in FIG. 8, a rotating shaft 300 is arranged at middle part of the width direction of the louver blades 32. The present utility patent does not require glass for shielding, so as to simultaneously satisfy the sunshade and ventilation of the sunroom, and facilitate later repair and maintenance.

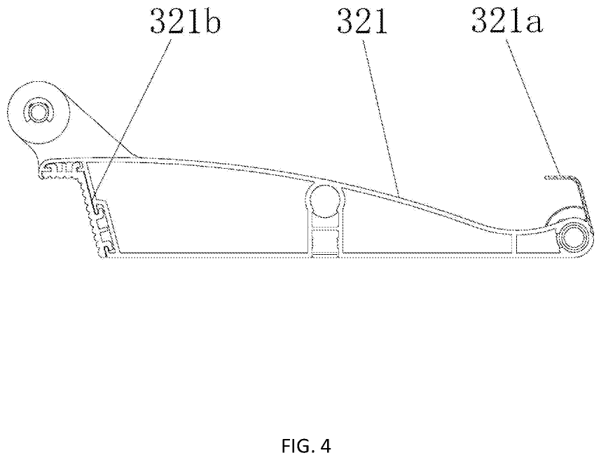

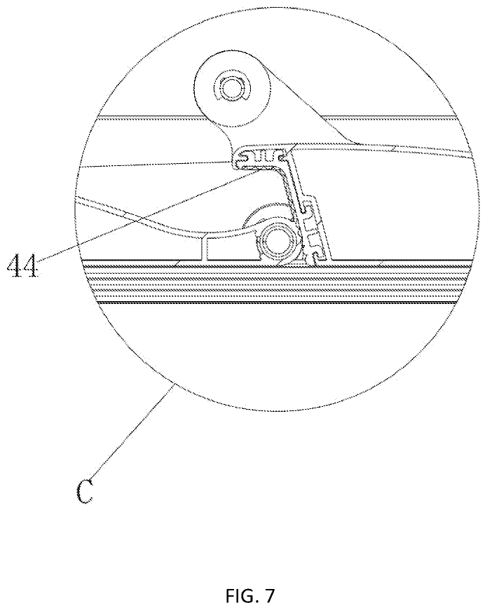

In this embodiment, each louver blade 32 comprise a transverse louver blade 321 and connecting plates 322 arranged at both ends of the transverse louver blade 321. Two ends of the connecting plates 322 are rotationally connected to the bracket 31 and the window frame 1. The transverse louver blade 321 is fixedly connected to the connecting plates 322 at two ends. Middle part of the connecting plate 322 is provided with a connecting hole extending into the transverse louver blade 321, which is fixedly connected by screws. Top surface of the transverse louver blade 321 is an inclined surface and bottom surface is a horizontal surface. As shown in FIG. 4, the transverse louver blade 321 is a sectional material plate with a certain thickness. The transverse louver blade 321 has a triangular cross-section with an inclined top surface and a flat bottom surface. The shape of the connecting plate 322 corresponds to the transverse louver blade 321 so that it can cover both ends of the transverse louver blade 321. The top surface of the transverse louver blade 321 corresponds to top surface of the connecting plate 322, and the bottom surface of the transverse louver blade 321 abuts against the drainage groove 4 when closed. As shown in left end of FIG. 4, the transverse louver blade 321 is connected to the bracket 31 through the rotating shaft 300 at upper end of the inclined surface. As shown in right end of FIG. 4, lower end of the inclined surface is connected to the window frame 1 through the rotating shaft 300. It should be noted that the connecting plates 322 are arranged at both ends of the transverse louver blade 321. The rotating shaft 300 is not directly arranged on the transverse louver blade 321. The two rotating shafts 300 are rotationally connected to the connecting plate 322 corresponds to the upper end and the lower end of the transverse louver blade 321. The drainage groove 4 is in contact with the lower end of the transverse louver blade 321. The transverse louver blade 321 is provided with a baffle 321a extending upward at the lower end of the transverse louver blade 321 located on the inclined surface, and is provided with a jointing part 321b at the upper end. The shape of the baffle 321a and the jointing part 321b can be referred to FIG. 4. The two adjacent transverse louver blades 321 abut the baffle 321a through the jointing part 321b. As shown in FIGS. 4 and 7, the jointing part 321b is provided with a sealing joint strip 44. When the adjacent transverse louver blade 321 are in a closed state, one of the transverse louver blade 321 abuts against the baffle 321a of the other transverse louver blade 321 through the jointing part 321b, thereby improving the sealing performance, and since the lower end of the transverse louver blade 321 is provided upward with the baffle 321a to resist rainwater and prevent rainwater from entering the contacting part between the two transverse louver blades 321. The rainwater staying on the transverse louver blades 321 flows into the drainage groove 4 from both ends of the transverse louver blades 321. By the means of changing a rotating axis of the current louver blade 32 as shown in FIG. 8 for the louver blade component, the drainage groove 4 does not need to reserve space for the rotation of the louver blades 32. One end of the louver blades 32 is connected to the window frame 1, and the other end is connected to the bracket 31. The driving device 2 extends to drive the bracket 31 to move from right to left; As the rotational connection structure of the driving device 2 provides sufficient sliding space for the bracket 31, the sliding trajectory of the bracket 31 is an arc, and the louver blades 32 are connected to the bracket 31, thereby driving the louver blades 32 to swing.

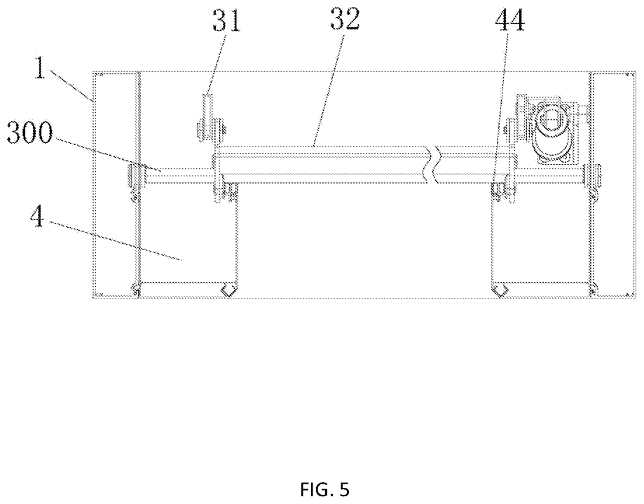

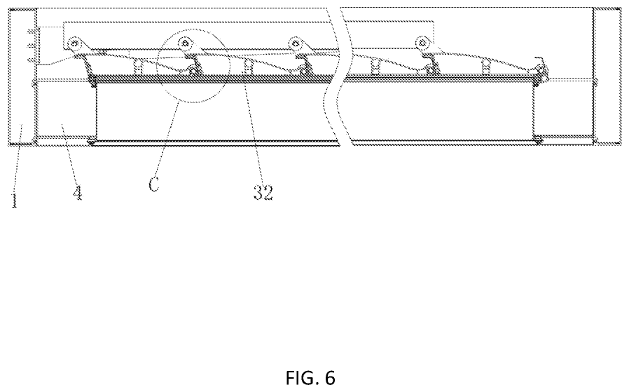

In this embodiment, one side wall of the drainage groove 4 is fixedly connected to the inner side of the window frame 1, and the other side wall is arranged at the lower side of the transverse louver blade 321 and is provided with a sealing joint strip 44 that closely abuts against the transverse louver blade 321. The sealing joint strip 44 can improve the sealing performance of the connection. The drainage groove 4 is U-shaped as shown in FIG. 5-6, and the lower end of the transverse louver blade 321 is arranged as an arc, so that the rotation of the transverse louver blade 321 is not affected.

In this embodiment, the driving device 2 is provided with a connector 200 installed on the bracket 31. As shown in FIG. 2, the connector 200 is rotationally connected to the driving device 2. The driving device 2 extends to drive the bracket 31 to move from right to left. The rotational connection structure of the driving device allows the bracket 31 to have enough space to swing during the sliding process. The bracket 31 realizes a movement along the arc, thereby causing the louver blades 32 connected to the bracket 31 to swing. The driving device 2 is arranged as inclined.

The above only aims to illustrate the technical solution of the present utility patent without limitation. Any other modifications or equivalent replacements of the technical solution of the present utility patent made by ordinary skilled in the art should be included in the scope of the claims of the present utility patent as long as they do not deviate from the technical solution spirit and scope of the present utility patent.

1. A roof shutter, comprising a window frame, a driving device and a louver blade component, wherein the louver blade component is arranged in the window frame and comprises at least two brackets, and each bracket is drivingly connected to the driving device, and a plurality of louver blades arranged between two brackets; one side of each louver blade is rotationally connected to one bracket, and other side is rotationally connected to the window frame;
a drainage groove is arranged on inner side of the window frame, and one side wall of the drainage groove away from the window frame is in contact with lower part of the louver blades; each louver blade comprises one transverse louver blade and two connecting plates, wherein the two connecting plates are arranged on two ends of each transverse louver blade; one end of the connecting plate is rotationally connected to the bracket, and other end of the connecting plate is rotationally connected the window frame.

2. The roof shutter according to claim 1, wherein top surface of the transverse louver blade is of inclined surface, while bottom surface of the transverse louver blade is of horizontal surface; upper end of the transverse louver blade located on the inclined surface is connected to the bracket through a rotating shaft, and lower end of the transverse louver blade located on the inclined surface is connected to the window frame through another rotating shaft.

3. The roof shutter according to claim 2, wherein the lower end of the transverse louver blade located on the inclined surface is provided with a baffle extending upward, the upper end of the transverse louver blade is provided with a jointing part on the inclined surface, and two adjacent transverse louver blades abut against the baffle through the jointing part.

4. The roof shutter according to claim 3, wherein a sealing joint strip is arranged on one side of the jointing part that abuts against the baffle.

5. The roof shutter according to claim 1, wherein one side wall of the drainage groove is connected to the inner side of the window frame, and other side wall is arranged at lower side of the transverse louver blade; the drainage groove is provided with a sealing joint strip that closely abuts against the transverse louver blade.

6. The roof shutter according to claim 1, wherein the driving device is provided with a connector installed on the bracket, and the connector is rotationally connected to the driving device.

7. The roof shutter according to claim 3, wherein two of the brackets are symmetrically arranged, louver blades are located between two brackets, and the driving device is installed in the window frame and is drivingly connected with one of the brackets.

8. The roof shutter according to claim 1, wherein each connecting plate's shape corresponds to a cross section shape of each transverse louver blade.
